(19) United States
(12) Patent Application Publication
(10) Pub. No.: US 2014/0243147 A1
(43) Pub. Date: Aug. 28, 2014

(54) Continuously Variable Transmission (CVT) Having a Coaxial Input/Output Arrangement and Reduced Friction Losses

(71) Applicant: TRANSMISSION CVTCORP INC., Ste-Julie (CA)

(72) Inventors: Kenneth Huston, Montreal (CA); Mathieu Guertin, Mont-Saint-Hilaire (CA); Rémi Tremblay, Ste-Julie (CA); François Messier, Varennes (CA)

(73) Assignee: TRANSMISSION CVTCORP INC., Ste-Julie (CA)

(21) Appl. No.: 14/190,223

(22) Filed: Feb. 26, 2014

Related U.S. Application Data
(60) Provisional application No. 61/770,442, filed on Feb. 28, 2013.

(51) Int. Cl. F16H 15/40

(52) U.S. Cl. CPC F16H 15/40
USPC 476/50

(57) ABSTRACT

A toroidal Continuously Variable Transmission provided with co-axial input/output arrangement where a drum assembly is used to transfer torque from a central driven disk of the CVT to the input or output shaft thereof. The drum assembly includes features to reduce the friction between the rotating drum and lubrication fluid present in the transmission.

### CROSS-REFERENCE TO RELATED APPLICATIONS

This application claims priority to and the benefit of U.S. provisional patent application No. 61/770,442, filed on Feb. 28, 2013, the entire contents of which are hereby incorporated by reference herein.

### FIELD

The present disclosure generally relates to continuously variable transmissions. More specifically, the present disclosure is concerned with a toroidal continuously variable transmission having a coaxial input/output arrangement and reduced friction losses.

### BACKGROUND

Toroidal Continuously Variable Transmissions (hereinafter generically referred to as “CVTs”) are believed known in the art. The operation of such a CVT will therefore only be briefly discussed herein.

Generally stated, a toroidal CVT is provided with a drive disk having a toroidal surface, a driven disk also having a toroidal surface, both disks being linked by rollers in contact with their respective toroidal surfaces. The angle of the rollers with respect to the drive and driven disks dictates the speed ratio between the driven and drive disks.

Often, toroidal CVTs are designed according to the so-called “dual cavity” configuration including two drive disks and a single driven disk having opposed toroidal surfaces and located between the two drive disks. When this is the case, one of the output and input of the CVT is provided about in the middle of the device, which may bring integration problems.

### BRIEF DESCRIPTION OF THE DRAWINGS

In the appended drawings:

FIG. 1 is a side elevation view of a CVT according to a first illustrative embodiment;

FIG. 2 is a sectional view of the CVT of FIG. 1;

FIG. 3 is exploded perspective view of the drum assembly of the CVT of FIG. 1;

FIG. 4 is a sectional view taken along line 4-4 of FIG. 3;

FIG. 5 is a sectional view similar to FIG. 4 but illustrating a second illustrative embodiment;

FIG. 6 is a sectional view similar to FIG. 4, illustrating a third illustrative embodiment; and

FIG. 7 is a sectional view similar to FIG. 4, illustrating a fourth illustrative embodiment.

### DETAILED DESCRIPTION

The use of the word “a” or “an” when used in conjunction with the term “comprising” in the claims and/or the specification may mean “one”, but it is also consistent with the meaning of “one or more”, “at least one”, and “one or more than one”. Similarly, the word “another” may mean at least a second or more.

As used in this specification and claim(s), the words “comprising” (and any form of comprising, such as “comprise” and “comprises”), “having” (and any form of having, such as “have” and “has”), “including” (and any form of including, such as “include” and “includes”) or “containing” (and any form of containing, such as “contain” and “contains”), are inclusive or open-ended and do not exclude additional, unrecited elements or process steps.

Other objects, advantages and features of the CVT will become more apparent upon reading of the following non-restrictive description of illustrative embodiments thereof, given by way of example only with reference to the accompanying drawings.

More specifically, in accordance with an aspect of the continuously variable transmission (CVT) having a coaxial input/output arrangement and reduced friction losses, there is provided a continuously variable transmission including:

a shaft defining a longitudinal axis; the shaft defining an input/output of the continuously variable transmission;

a drive disk mounted to the shaft and provided with a toroidal surface;

a driven disk rotatably mounted to the shaft and having a toroidal surface facing the toroidal surface of the drive disk, and a peripheral surface;

a set of rollers interconnecting the toroidal surface of the first drive disk with the first toroidal surface of the driven disk; and

a drum assembly enclosing the drive disk; the drum assembly having a first longitudinal end defining an output/input of the continuously variable transmission and a second longitudinal end connectable to the driven disk; the drum assembly including shaped apertures therethrough allowing lubrication fluid to egress the drum assembly; stretches of material between adjacent apertures having a wedge shape.

Generally stated, illustrative embodiments described herein are concerned with a dual-cavity toroidal CVT provided with co-axial input/output arrangement where a drum assembly is used to transfer torque from a central driven disk of the CVT to the output shaft of the CVT and including shaped apertures allowing traction oil to pass therethrough while limiting the friction created between the rotating drum assembly and the traction oil.

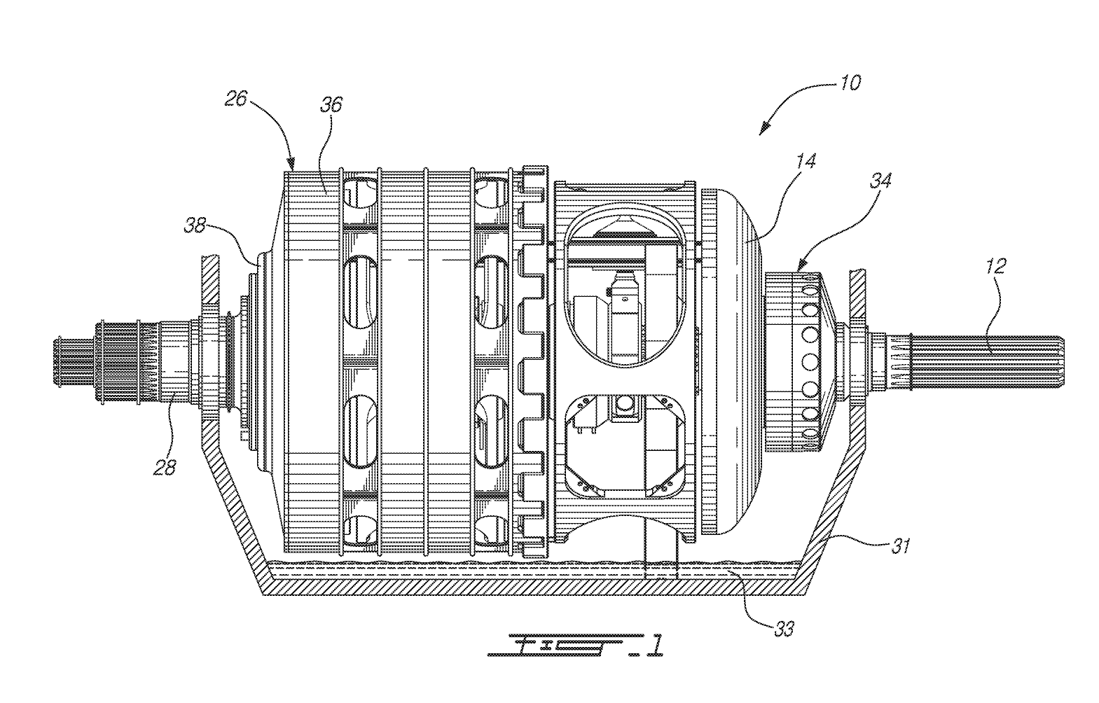

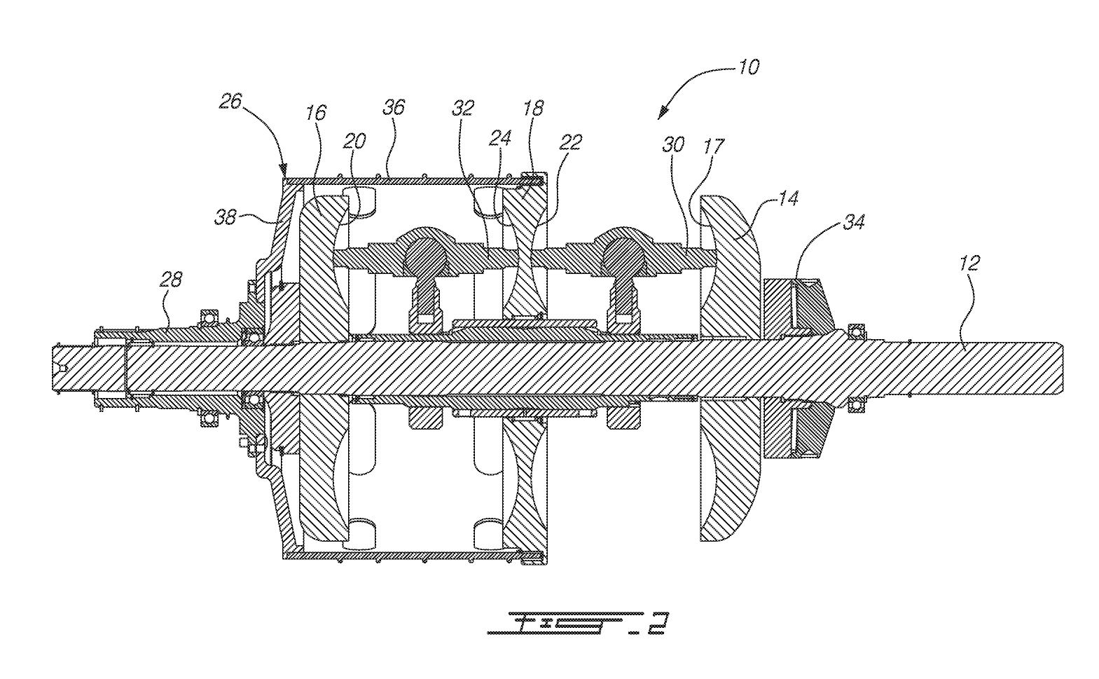

As shown in FIGS. 1 and 2, a first illustrative embodiment provides a toroidal continuously variable transmission 10 that includes an input shaft 12 for receiving power from a prime mover (not shown), two drive disks 14, 16 provided with respective toroidal surfaces 17, 20, a driven disk 18 provided with two opposite toroidal surfaces 22, 24 respectively facing the toroidal surfaces 17 and 20 and a drum assembly 26 including an output shaft 28 transmitting the power output.

Positioned between the drive disks 14 and 16 and the driven disk 18 are drive rollers 30, 32 that are suitable for transferring rotational motion from the drive disks 14 and 16 to the driven disk 18. More specifically, the drive rollers 30, 32 rotate between the toroidal surfaces of the drive disks 14, 16 and the driven disk 18, such that by changing the angle of the drive rollers 30, 32 in relation to the drive disks 14, 16 and the driven disks 18, there is a ratio change between the speed of rotation of the drive disks 14, 16 and the speed of rotation of the driven disk 18, thereby providing a continuously variable transmission.

The drive shaft 12 is fixedly connected to the drive disk 16 and to a tension applying mechanism 34 that is positioned next to the drive disk 14 to exert a compression force on the drive disk 14.

As the drive disks 14, 16 rotate, they cause the drive rollers 28, 30 to rotate, which in turn causes the driven disk 18 to rotate. The driven disk 18 rotates about the same axis as the drive disks 14, 16 and the drive shaft 12.

The transmission 10 is mounted inside a transmission casing 31 partially shown in FIG. 1. The casing 31 protects the transmission 10 and acts as a reservoir for the lubricating fluid 33.

As can be better seen from FIG. 2, the drum assembly 26 includes a tubular drum 36, a flange 38 and the aforementioned output shaft 28. The drum assembly 26 therefore has a first end defining the output shaft of the CVT 10 and a second end mounted to the outer circumference of the driven disk 18. As such, the tubular drum 36 surrounds the drive rollers 30 that are positioned between the driven disk 18 and the drive disk 16. The output shaft 28 is positioned around the input shaft 12 such that the output shaft 28 and the input shaft 12 are coaxial. It should be appreciated that the drum assembly 26 could be positioned on either side of the driven disk 18, such that the output shaft 28 could be positioned on either side of the CVT 10.

Of course, one skilled in the art will understand that the drum assembly 26 could be constructed differently. As a non-limiting example, the tubular drum 26 and the flange 38 could be integral.

The drum assembly 26, including the tubular drum 36, the flange 38 and the output shaft 28 may retrieve torque from the center disk 18 and transmit that torque without significantly affecting efficiency.

Conventionally, during the CVT operation, lubrication fluid, particularly so-called traction fluid, is applied to the CVT such that there is no or minimal metal-on-metal contact between the rollers and the disks. Instead, a film of lubricating fluid is present between the moving parts, and specifically between the drive rollers 30, 32 and the toroidal surfaces of the drive disks 14, 16 and the driven disk 18.

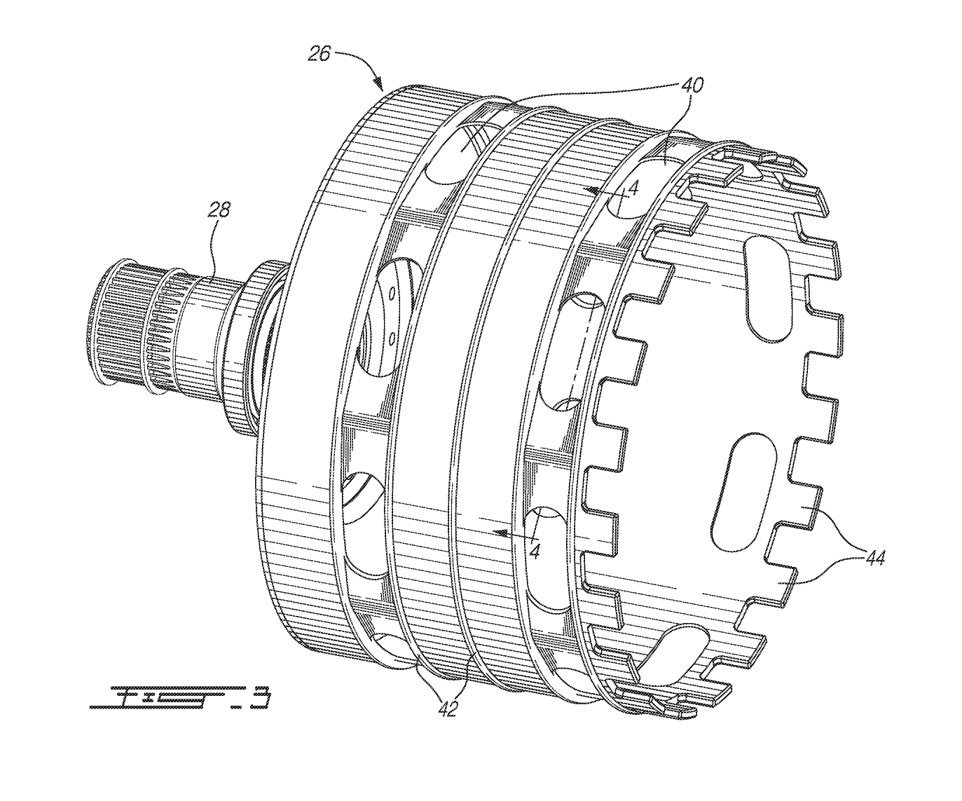

As can be better seen from FIG. 3, the tubular drum 36 includes a plurality of oblong apertures 40 allowing the lubrication fluid 33 to drain out of the tubular drum 36. Indeed, the lubrication fluid 33 has a secondary use as a cooling fluid and must egress the tubular drum 36 to be cooled. FIG. 1 shows that the bottom of the casing 31 enclosing the transmission 10 is therefore used to hold a quantity of lubrication fluid 33.

It should be appreciated that the apertures 40 can be of any shape and size, so long as they allow the transfer of the lubrication fluid 33 from inside the tubular drum 36 to outside the tubular drum 36. The apertures 40 act as drainage holes to allow the lubrication fluid to drain out of the cavity where the drive rollers 32 are located. Once outside the tubular drum 36, the lubrication fluid may move along the outer casing 31 of the CVT.

FIG. 3 of the appended drawings illustrate the drum assembly 26 in a perspective view. As can be better seen from this figure, the drum assembly 26 includes circumferential external reinforcing ribs 42. Teeth 44 are provided to interconnect the drum assembly 26 to the output disk 18. One skilled in the art will understand that other types of suitable mechanical interconnections could be used between the drum assembly and the output disk 18.

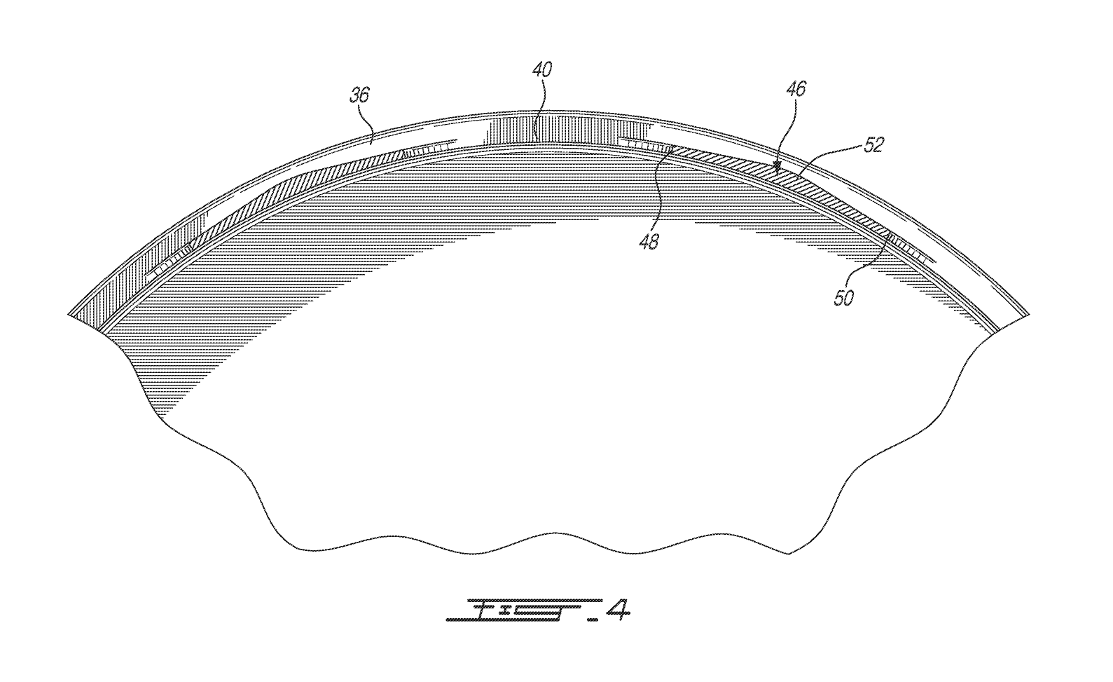

Turning now to FIG. 4 of the appended drawings, illustrating a sectional view taken across some of the apertures 40, the shape of the stretch of material 46 provided between the apertures 40 and forming the drum will be discussed.

As can be seen from this figure, the stretch of material 46 is not uniformly thick but has a double wedge shape. Accordingly, the edges 48 and 50 of the stretch of material that define the apertures 40 are thinner than the center portion 52 thereof, thereby decreasing the surface of forceful contact between the drum assembly 26 and the lubricating fluid 33 when the drum assembly is rotating. This decrease in surface therefore reduces the friction between the drum assembly 26 and the lubricating fluid 33 to thereby improve the overall efficiency of the transmission.

Indeed, since the lubricating fluid is moved at high speed by the rotating disks 16 and 18, some of the fluid droplets are moved in the direction opposite the direction of rotation of the tubular drum 36 and are therefore impacting the edges of the stretches of material that define the apertures 40. Accordingly, having the edges 48 and 50 as thin as possible decreases the number of impacts with fluid droplets and therefore improves the overall efficiency of the CVT.

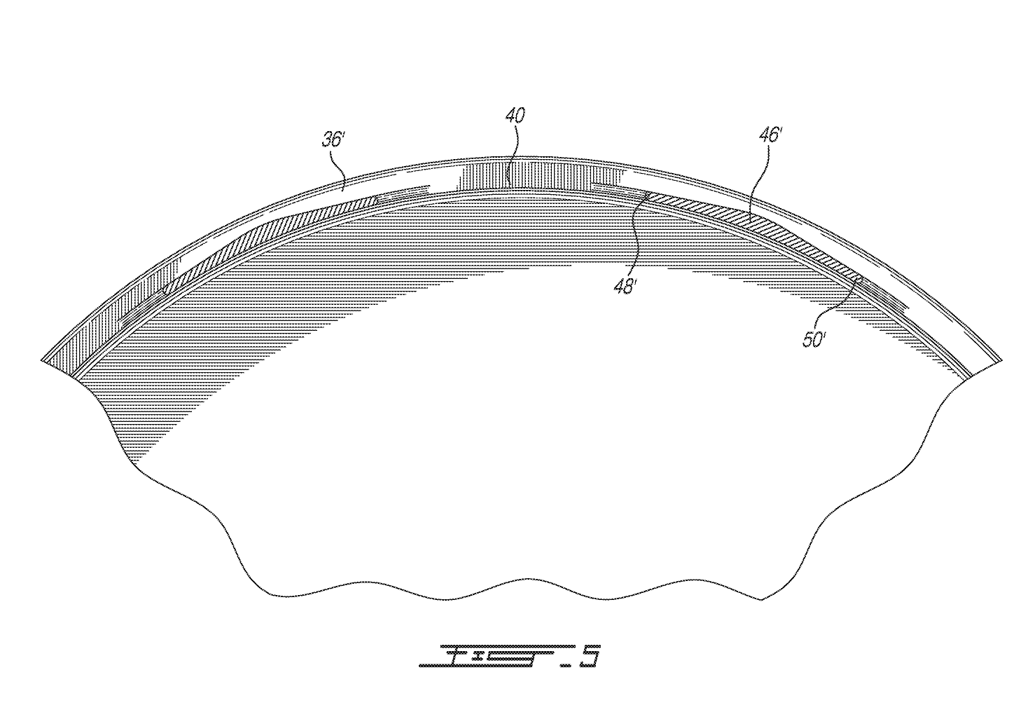

FIG. 5 of the appended drawings illustrates a second embodiment of the stretch of material 46′ where the edges 48′ and 50′ are completely rounded to further reduce the friction between the rotating tubular drum 36′ and the lubricating fluid droplets.

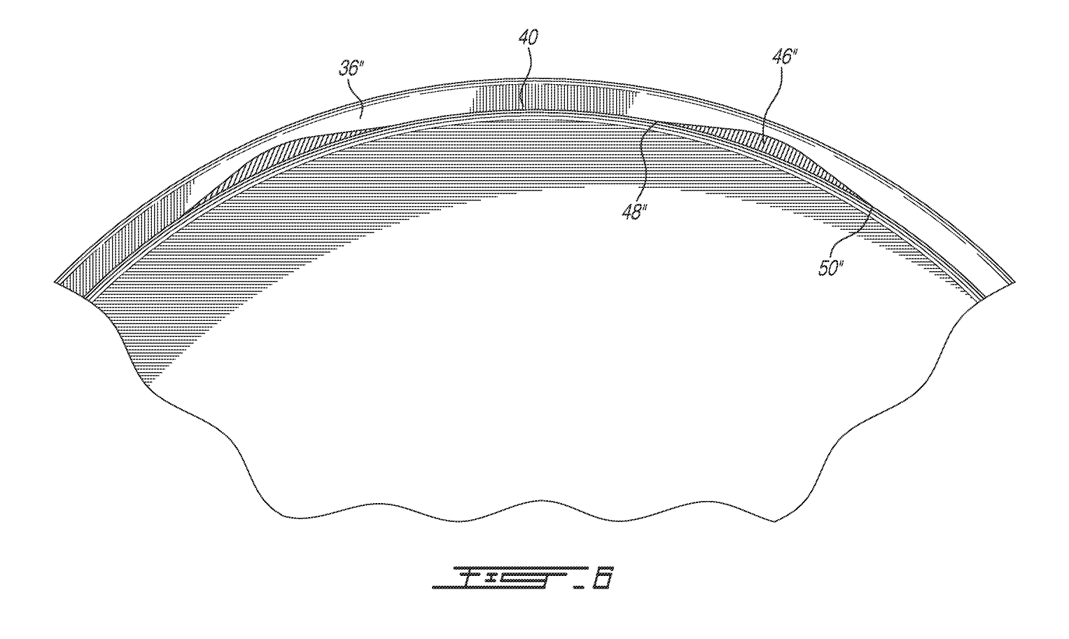

FIG. 6 of the appended drawings illustrates a third embodiment of the stretch of material 46″ where the edges 48″ and 50″ are completely thinned out to a knife edge to further reduce the friction between the rotating tubular drum 36′ and the lubricating fluid droplets.

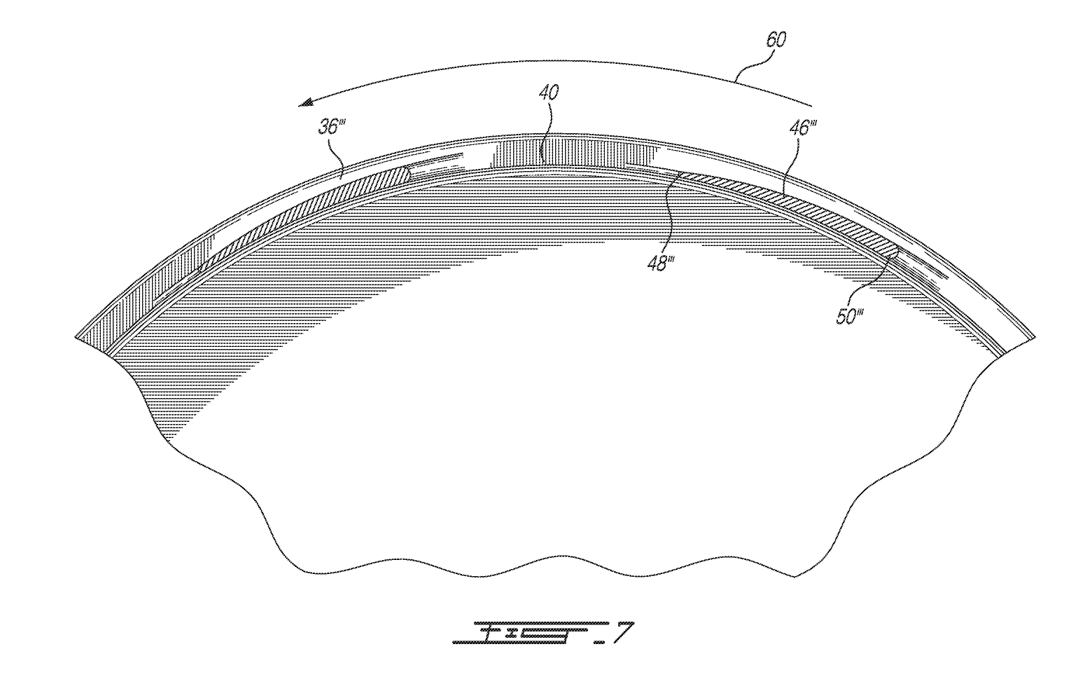

Finally, FIG. 7 of the appended drawings illustrates a fourth embodiment of the stretch of material 46′″ where only edge 48′″ has been thinned. The drum assembly of FIG. 7 is intended for applications where the efficiency is important only in one rotation direction of the drum (shown by arrow 60). Of course, the drum may still rotate in both directions.

While the above description states that the shaft 12 is used to input mechanical power into the CVT and the shaft 28 is used to output mechanical power from the CVT, these roles of the shafts 12 and 28 could be reversed. In other words, mechanical power could be supplied to the CVT via the drum assembly and could be outputted from the CVT via the shaft 12.

It will also be understood that while the drum assembly 26 has been described and illustrated herein in details, other drum assemblies could be designed with the stretch of material provided between the apertures as taught herein.

Furthermore, the shape, dimensions and locations of the apertures 40 and of the interconnecting stretches of material 46, 46′, 46″, and 46′″ could be different from the ones illustrated herein as long as the thinning edge feature of the stretch of material is present to reduce the friction between the drum assembly and the lubrication fluid. While the above illustrative embodiments were concerned with a dual-cavity CVT, one skilled in the art will understand that a single-cavity CVT would also benefit from the above teachings. For example, should one wish to design a single cavity CVT provided with coaxial and concentric input/output provided on the same side of the CVT using a drum assembly.

It is to be understood that the continuously variable transmission is not limited in its application to the details of construction and parts illustrated in the accompanying drawings and described hereinabove. The continuously variable transmission is capable of other embodiments and of being practiced in various ways. It is also to be understood that the phraseology or terminology used herein is for the purpose of description and not limitation. Hence, although the continuously variable transmission has been described hereinabove by way of illustrative embodiments thereof, it can be modified, without departing from the spirit, scope and nature as defined in the appended claims.

What is claimed is:

1. A continuously variable transmission including:
a shaft defining a longitudinal axis; the shaft defining an input/output of the continuously variable transmission;
a drive disk mounted to the shaft and provided with a toroidal surface;
a driven disk rotatably mounted to the shaft and having a toroidal surface facing the toroidal surface of the drive disk, and a peripheral surface;
a set of rollers interconnecting the toroidal surface of the first drive disk with the first toroidal surface of the driven disk; and
a drum assembly enclosing the drive disk; the drum assembly having a first longitudinal end defining an output/input of the continuously variable transmission and a second longitudinal end connectable to the driven disk; the drum assembly including shaped apertures therethrough allowing lubrication fluid to egress the drum assembly; stretches of material between adjacent apertures having a wedge shape.

2. A continuously variable transmission as recited in claim 1, further comprising a second drive disk mounted to the shaft and provided with a toroidal surface facing a second toroidal surface of the driven disk; a second set of rollers interconnects the toroidal surface of the second drive disk with the second toroidal surface of the driven disk.

3. A continuously variable transmission as recited in claim 1, wherein the stretches of material have a double wedge shape.

4. A continuously variable transmission as recited in claim 1, wherein the wedge shape of each of the stretches of material between adjacent apertures defines a thinner portion of material at the edge of the aperture.

5. A continuously variable transmission as recited in claim 4, wherein the thinner portion of material of the wedge shape is rounded.

6. A continuously variable transmission as recited in claim 4, wherein the thinner portion of material of the wedge shape is thinned out to a knife-edge.

7. A continuously variable transmission as recited in claim 1, wherein the apertures are oblong.
